(19) United States
(12) Patent Application Publication
(10) Pub. No.: US 2014/0293865 A1
(43) Pub. Date: Oct. 2, 2014

(54) DYNAMIC EVACUATION INFORMATION DELIVERY TO MOBILE DEVICES

(71) Applicants: Yuntao Shi, Beijing (CN); ZhiGang Zhang, Beijing (CN); YanFeng Zhang, Beijing (CN); Xiaojun Ma, Beijing (CN)

(72) Inventors: Yuntao Shi, Beijing (CN); ZhiGang Zhang, Beijing (CN); YanFeng Zhang, Beijing (CN); Xiaojun Ma, Beijing (CN)

(73) Assignee: Thomson Licensing, Issy de Moulineaux (FR)

(21) Appl. No.: 14/353,500

(22) PCT Filed: Nov. 14, 2011
(86) PCT No.: PCT/CN2011/082150

§ 371 Date: Apr. 23, 2014

(51) Int. Cl. H04W 4/22; H04L 12/18

(52) U.S. Cl. CPC H04W 4/22; H04L 12/189
USPC 370/312

(57) ABSTRACT

A method for delivering dynamically updated evacuation information to mobile communication devices (12₁-12ₙ) users commences by first dynamically updating evacuation information associated with a building premises and storing such information for retrieval. A building premise undergoes monitoring to detect an emergency condition, for example fire, earthquake or the like. In response to an emergency condition, the stored evacuation information is retrieved and then multicasted to mobile communication devices on a common Internet Protocol (IP) address over a wireless network.

### TECHNICAL FIELD

This invention relates to a technique for delivering dynamically updated evacuation information, such as a map, to mobile communication device users.

### BACKGROUND ART

Most communities impose safety regulations on commercial buildings to protect building occupants in the event of a fire or other disaster. Depending on the size and nature of building use, such safety regulations often require the installation of fire alarms and, in some instances, sprinkler systems. In addition, such safety requirements also impose the obligation on building managers to place lighted signs at building exits and to display evacuation maps at prominent locations to enable building occupants to locate the building exits quickly. However, a building occupant will typically have only a limited time to view such a map during an emergency evacuation. Thus, during a building evacuation, a building occupant must rely on his or her memory of the map to plan a suitable evacuation route.

To alert patrons in a movie theater of possible evacuation routes, most theater operators display an evacuation map at the outset of a feature presentation (i.e., display of a movie). In the event of an actual emergency, theater operators will display the evacuation map. While display of the evacuation map on the theater screen obviates the problem of patrons having to locate the map on a building wall, this approach to alerting movie theater patrons has obvious disadvantages. A movie theater patron typically only has a limited time to view such a map during an emergency evacuation. Thus, during evacuation of the theater, the move theater patron must rely on his or her memory of the map to plan a suitable evacuation route.

The proliferation of mobile wireless communications devices having Global Positioning Satellite capability (GPS) affords device users the ability to obtain turn-by-turn directions and might seem a potential mechanism for aiding a building occupant in the event an emergency evacuation. However, GPS does not work well indoors and usually does not offer the selectivity needed in close quarters.

Thus, a need exists for providing all building occupants with a dynamically updated map in the event of a need for an emergency evacuation.

BRIEF SUMMARY OF THE INVENTION

Briefly, a method for delivering dynamically updated evacuation information to mobile communication device users commences by first dynamically updating evacuation information associated with a building premises and storing such information for retrieval. A building premise undergoes monitoring to detect an emergency condition, for example fire, earthquake or the like. In response to an emergency condition, the stored evacuation information is retrieved and then multicasted to mobile communication devices on a common Internet Protocol (IP) address over a wireless network.

### BRIEF DESCRIPTION OF THE DRAWINGS

FIG. 1 depicts a block schematic diagram of a system for delivering dynamically updated evacuation information to mobile communications devices in accordance with a preferred embodiment of the present principles;

FIG. 2A depicts a screen of a first mobile communication device, showing evacuation information for a first location;

FIG. 2B depicts a screen of a second mobile communication device, showing evacuation information for a second location; and

FIG. 3 depicts the steps of a method practiced by a mobile communications device to receive dynamically updated evacuation information from the system of FIG. 1 in accordance with a preferred embodiment of the present principles.

### DETAILED DESCRIPTION

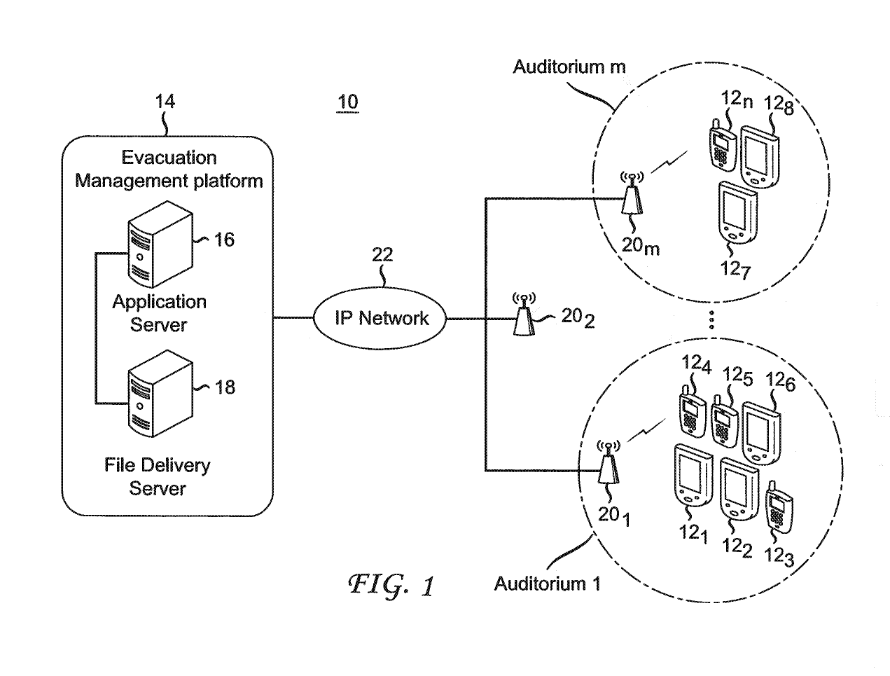

FIG. 1 depicts a block schematic diagram of a system 10, in accordance with a preferred embodiment of the present principles for delivering dynamically updated evacuation information, such as one or more evacuation maps, to a plurality of mobile communication devices, illustratively depicted by mobile communications devices 12ₖ, 12₂, 12_{3 . . . 12}ₙ where n is an integer. The mobile communications devices 12₁-12ₙ can take various forms, for example, cellular telephones (including, but not limited so-called “smart phones”), personal data assistants (PDAs), and mobile computers; provided that the devices have the capability of receiving wireless communications using a Wi-Fi protocol or other know communications method.

The system 10 includes an evacuation management platform 14 that dynamically updates and stores evacuation information. The evacuation information typically includes one or more evacuations maps. Each evacuation map illustrates evacuation routes and building exits for all or a selected portion of a building premise. In the case of a movie theater, each evacuation map will illustrate evacuation routes and building exits for an individual auditorium.

The evacuation management platform 14 of FIG. 1 includes an application server 16, in the form of a programmed computer or equivalent structure. The application server 16 generates, manages and updates the evacuation information. Typically, the application server 16 updates the evacuation information in response to updates entered with respect to the phyical changes in the building premise. The updates could include changes related to building occupancy such as locations of building occupants which could impact possible evacuation routes. For example, should a building exit become unavailable due to contruction or should the layout of builiding occupants change, the building manager will update the evacuation information to reflect such changes.

The application server 16 also establishes a multicast IP address and port information for transmitting the evacuation information for receipt by a file delivery server 18. The file delivery server 18 stores the evacuation information received from the application server 16. The evacuation information stored by the file delivery server 18 resides within at least one specified directory for subsequent access. Upon detecting an emergency condition, the file delivery server 18 retrieves the evacuation information. The detection of an emergecy condition can occur in different ways. For example, a link can exist between the file delivery server 18 and a building alarm system or other monitoring mechanism (not shown) for detecting an emergency condition. Further, a manual switch operated by a building attendent could signal an emergency condition to the file delivery server 18.

Following retrieval of the evacuation information by the file delivery server 18 in the event of an emergency condition, the file delivery server will undertake processing of the retrieved information, for example, by perforiming information fragmentation and compression, to enable multicasting of the evacuation information to the mobile communications devices 12₁-12ₙ. To undertake such multicasting, the file delivery server 18 can make use of the FLUTE protocol to configure the period time of loop transmission. During each burst cycle, the file delivery server 18 delivers the evacuation information to destinated ports associated with the multicast IP address. The delivery of evacuation information by the file delivery server 18 in a loop mode enables the mobile communications devices to receive evacuation information essentially on demand.

In the illustrated embodiment, the application server 16 and the file delivery server 18 appear as physically distinct entities. Those skilled in the art should readily appreciate that a single server (not shown) could easily perform the separate functions of the the application server 16 and the file delivery server 18.

Multicast transmission of the evacuation information to the mobile communications devices 12₁-12ₙ occurs by way of a set of transmission hubs 20₁, 20₂ . . . 20ₘ, where m is an integer. Typically, each transmission hub comprises a wireless base station, which makes use the Wi-Fi protocol, although other wireless transmission protocols could be used, assuming appropriate formatting of the evacuation information by the file delivery server 18. In practice, the transmission hubs 20₁-20ₘ reside in different locations within the building premise for broadcasting evacuation information specific to that location. For example, in a movie theater, each auditorium would have a different transmission hub. Thus, as illustrated in FIG. 1, transmission hub 20₁ transmits evacuation information within a first auditorium (designated as “Auditorium 1); whereas transmission hub 20ₘ transmits evacuation information within the m^{th} auditorium. The transmission hubs 20₁-20ₘ receive evacuation information from the evacuation management platform 14 via an Internet Protocol (IP) network 22.

The use of the Wi-Fi protocol to transmit evacuation information allows each mobile communication device to respond to a default multicasting IP address to obtain the information. The multicasting of the evacuation information services via the wireless transmission hubs 20₁-20ₘ advantageously enables simultaneous receipt of evacuation information. For example, a mobile communication device will receive evacuation information (e.g., an evacuation map) specific to Auditorium 1 when the device user enters that auditorium to view a movie. In the event of an emergency, the file delivery server 18 will retrieve dynamically updated evacuation information and decrease the loop period to insure that the mobile communications device receives the latest evacuation information. A mobile device user can thus make use of the received evacuation information to evacuate the building premise. As long as the system 10 continues to transmit, and the mobile communication device continues to receive, evacuation information, the device user can make use of that evacuation information to efficient exit the building premise during an emergency. The evacuation information, and especially an evacuation map can include visual environmental cues (i.e. signs, landmarks, and the like) for use by the device user to track his or her position and maintain his or her the orientation.

The use of the Wi-FI transmission protocol to transmit the evacuation information has several advantages. First, many building premises already make use of Wi-Fi so that an infrastructure already exists for transmitting evacuation information. Further, a mobile communications device can readily estimate its location by measuring the signal strength of a received Wi-Fi packet. Further, each transmission hub has a name corresponding to its location (e.g., “Auditorium 1”) which will aid the mobile communication device to estimate its position.

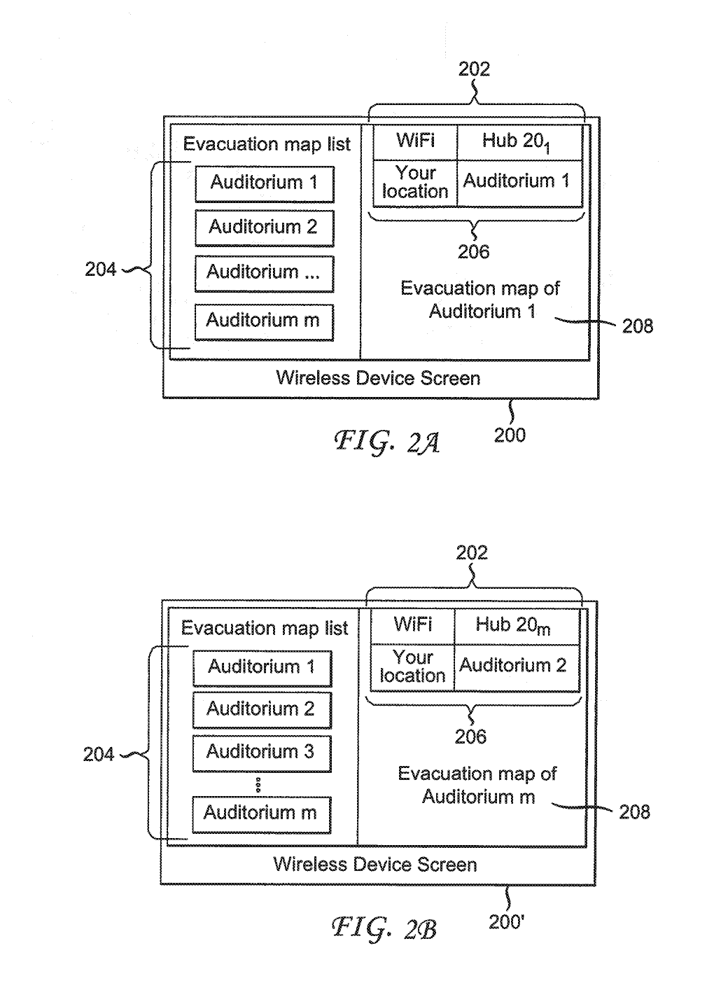

FIG. 2A depicts a display screen 200 of a first mobile communications device (not shown) during display of evacuation information for at least a part of a building premise. In the illustrated embodiment, the building premise comprises a movie theater having at least one and as many as m separate auditoriums. In practice, when displaying evacuation information, the display screen 200 of FIG. 2A will display an indicator 202 which indicates the particular transmission hub transmitting Wi-Fi signals to the mobile communications device.

The evacuation information displayed on the display screen 200 of FIG. 2A typically includes a listing 204 of evacuation maps for different portions of the building premise. Should the building premise comprise a movie theater, the listing 204 will list the evacuation maps associated the individual auditoriums. The mobile device user can select an evacuation map for a given auditorium, say auditorium 1, whereupon a location indicator 206 will indicate the particular location selection. The selected evacuation map will appear in a map display area 208 within the display screen 200.

FIG. 2B depicts a screen 200′ of second mobile communications device (not shown) during display of evacuation information for at least a part of a building premises. As with the display screen 200 of FIG. 2A, during display of evacuation information, the display screen 200′ will display the indicator 202, the evacuation map list 204, the location indicator 206 and the map display area 208. The information appearing on the display screen 200′ of FIG. 2B differs from the information displayed on the screen 200 of FIG. 2A because of the different mobile communication device locations. In particular, the location indicator 206 appearing in the display screen 200′ of FIG. 2B will reflect the presence of the mobile communications device within auditorium m by virtue of the receipt of Wi-Fi signals from transmission hub 20ₙ of FIG. 1, as indicated by the display indicator 202 of FIG. 2B. Under such circumstances, the mobile communications device user would typically select the evacuation map for auditorium m for display in display area 208.

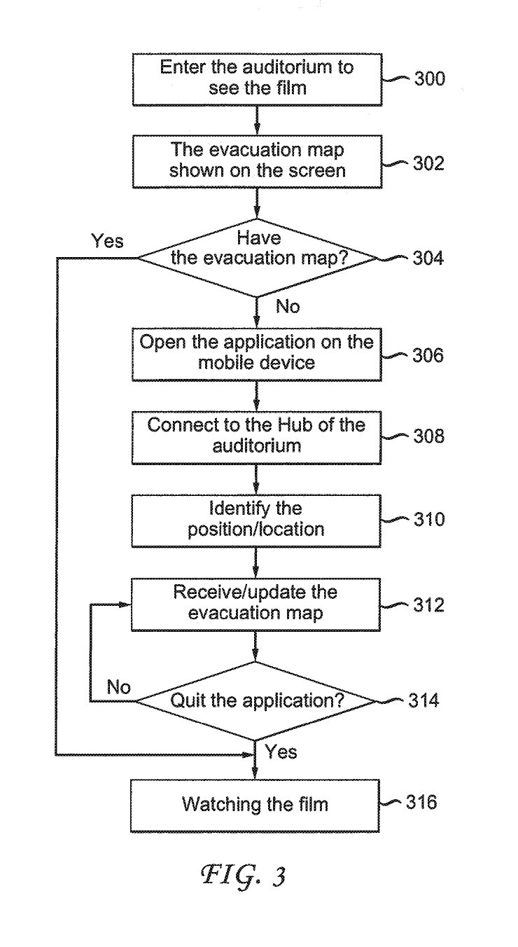

FIG. 3 depicts the steps of a method practiced by each mobile communications device to receive delivering dynamically updated evacuation information from the system 10 of FIG. 1 in accordance with a preferred embodiment of the present principles. The method of FIG. 3 commences upon execution of step 300, which corresponds to the entry into a particular portion of a building premises by a mobile communications device, such as entry into particular auditorium of a movie theater. At the outset of display of the feature presentation within that auditorium, the theater operator will display an evacuation map on the theater screen during step 302. The display of the evacuation map during step 302 will typically prompt the mobile communications device user to check during step 304 whether the mobile communication device current has most recent copy of the evacuation information for the corresponding auditorium.

If the mobile communications device does not have the most recent evacuation information, the user will then open an application on the device during step 306 to initiate acquisition of updated evacuation information. The opening of such an application on the mobile communications triggers the device to connect to the corresponding transmission hub within the auditorium during step 308. Once the mobile communications device connects to the transmission hub, the device display screen will identify the device location during step 310.

With knowledge of the mobile communications device, the user can select the appropriate evacuation information (e.g., the corresponding evacuation map) for receipt during step 312. During step 314, a decision occurs regarding whether to quit the application to acquire evacuation information. If the evacuation information has not been completely received, then step 312 undergoes re-execution to complete acquisition of the evacuation information. Otherwise, upon receipt of all the evacuation information during step 314, then step 316 occurs and the application to acquire evacuation information closes. During step 316, the user will watch the movie. Execution of step 316 occurs after step 304 upon a determination that the mobile communications device already stores updated evacuation information.

The foregoing describes technique for delivering dynamically updated evacuation information, such as a map, to mobile communication device users.

1. A method for delivering dynamically updated evacuation information to mobile communication device users, comprising the steps of:
dynamically updating evacuation information associated with a building premise and storing such information for retrieval;
monitoring a building premise to detect an emergency condition, and in response to an emergency condition,
retrieving the stored evacuation information; and
multicasting the retrieved evacuation information to mobile communication devices on a common Internet Protocol (IP) address over a wireless network.

2. The method according to claim 1 wherein dynamic updating of the updating evacuation information occurs in response to physical changes in the building premise. communication devices on a common Internet Protocol (IP) address over a wireless network.

3. The method according to claim 1 wherein dynamic updating of the updating evacuation information occurs in response to changes in layout of building occupants. communication devices on a common Internet Protocol (IP) address over a wireless network.

4. The method according to claim 1 wherein multicasting step includes the step of transmitting the evacuation information using a Wi-FI transmission protocol. communication devices on a common Internet Protocol (IP) address over a wireless network.

5. Apparatus for delivering dynamically updated evacuation information to mobile communication device users, comprising the steps of:
an evacuation management platform for dynamically updating evacuation information associated with a building premise and storing such information for retrieval in response to an emergency condition, and
a multicast transmission device for wirelessly transmitting the retrieved evacuation information to mobile communication devices on a common Internet Protocol (IP) address.

6. The apparatus of claim 5 wherein the evacuation management platform comprises:
an application server for generating, managing and updating the evacuation information; and
a file delivery server for storing evacuation information received from the application server.

7. The apparatus according to claim 6 wherein the file delivery server stores the evacuation information in a designated directory.

8. The appratus according to claim 5 wherein the transmission system includes a plurality of wireless transmission hubs, each situated with a particular portion of a building premises for transmitting evacuation information corresponding to that location.

9. The apparatus according to claim 5 further including an IP network for communicating the retrieved evacuation information from the evacuation management platform and the multicast transmission device.

10. The apparatus according to claim 6 wherein the file delivery server delivers the retrieved evacuation information to the multicasting transmission device in a loop mode.
